(19) United States
(12) Patent Application Publication
(10) Pub. No.: US 2024/0011884 A1
(43) Pub. Date: Jan. 11, 2024

(54) SYSTEMS AND METHODS FOR IDENTIFYING PROTEIN AGGREGATES IN BIOTHERAPEUTICS

(71) Applicant: ABBVIE INC., North Chicago, IL (US)

(72) Inventors: Edmund Matayoshi, Richmond, IL (US); Sheng Tu, Libertyville, IL (US); Jie Wang, Lake Bluff, IL (US)

(73) Assignee: ABBVIE INC., North Chicago, IL (US)

(21) Appl. No.: 18/217,796

(22) Filed: Jul. 3, 2023

Related U.S. Application Data
(63) Continuation of application No. 17/583,609, filed on Jan. 25, 2022, now abandoned.
Application No. 17/583,609 is a continuation of application No. 16/940,893, filed on Jul. 28, 2020, now abandoned.
Application No. 16/940,893 is a continuation of application No. 16/189,700, filed on Nov. 13, 2018, now abandoned.
(60) Provisional application No. 62/337,170, filed on May 16, 2016.

(51) Int. Cl. G01N 15/02; G01N 15/06; G01N 21/90; G01N 21/51; G01N 21/64; H04N 23/56; G06T 7/00; G06T 7/60

(52) U.S. Cl. CPC G01N 15/0227; G01N 15/06; G01N 21/9027; G01N 21/51; G01N 21/6486; H04N 23/56; G06T 7/0002; G06T 7/60; G01N 2015/0693; G01N 2015/0053

(57) ABSTRACT

Systems and methods for inspecting particles in a liquid beneficial agent are provided. Inspecting particles in a liquid beneficial agent includes selectively illuminating at least a portion of a liquid beneficial agent contained within a container using an excitation beam configured to excite photoluminescent particles in the liquid beneficial agent to emit an emission light and produce scattered excitation light, filtering the illuminated portion of the liquid beneficial agent to transmit the emission light and block the scattered excitation light, obtaining an image of the filtered emission light, analyzing image data representing the image of the filtered emission light to detect regions of the image representing the intrinsic photoluminescence of the photoluminescent particles, measuring an intensity of the regions of the image representing the intrinsic photoluminescence of the photoluminescent particles, and determining a size or number of the photoluminescent particles from the measured intensity of the regions.

### CROSS-REFERENCE TO RELATED APPLICATION

This application claims the benefit of U.S. Provisional Patent Application No. 62/337,170, filed May 16, 2016, which is incorporated by reference herein in its entirety.

### BACKGROUND

### Field of the Disclosed Subject Matter

The present disclosed subject matter relates to systems and methods for inspecting particles in a liquid beneficial agent, including systems and methods for identifying and distinguishing certain particles, such as protein monomers and aggregates, from other visible, subvisible, and submicron particles, such as silicone oil droplets and micro air bubbles, in a liquid beneficial agent, such as protein-based therapeutic solutions.

### Description of Related Art

Protein biologics can present challenges different from other therapeutic solutions, such as small molecule drugs. For example, and without limitation, protein biologics can be made from living cells and thus can have some degree of chemical and physical heterogeneity, and their molecular weight and structural complexity can underlie great conformational flexibility and reduced or limited physical stability. The protein concentration in biopharmaceuticals can be high (for example and without limitation in a range of about 10-100 mg/mL), which can make molecular aggregation challenging to detect and control at all stages from production of the formulated protein through packaging and storage in the delivery device.

Certain methods exist to characterize aggregation in protein based therapeutics. For example, size-exclusion chromatography (SEC) can resolve monomers from small soluble oligomers. However, SEC can be considered a non-equilibrium invasive methodology. As such, SEC can be unsuitable for investigating the dependence of aggregation on protein concentration, at least in part because SEC typically cannot be performed at the high protein concentrations relevant to the drug product, and substantial dilution (e.g., from the injected concentration) can occur during the chromatographic process. In addition, SEC analyses can be restricted to buffers, which can differ greatly from the desired formulation solution at least in part because protein-column interactions can be sensitive to SEC mobile phase composition. The flow of aggregates larger than about 0.1 microns (e.g., column dependent) through columns may be restricted and thus can be excluded from detector chromatograms, which may result in a distorted analysis of aggregate size and extent.

Nanoparticle Tracking Analysis (e.g., Malvern/NanoSight) and Dynamic Light Scattering can also be used to evaluate protein aggregation. However, each of these techniques can be considered invasive, can encounter procedural challenges when concentrations are moderately high, and may be unsuitable to distinguish protein particles from other particles, such as silicone oil (used as a lubricant in syringes), micro air bubbles, or other foreign particles. One approach to addressing the challenge of particle discrimination is single particle image analysis, applied by methods such as Micro-Flow Imaging™ (e.g., ProteinSimple), FlowCam™ (e.g., Fluid Imaging Technologies), and Flow Particle Image Analyzer (e.g., Malvern). In these systems, differentiation of protein aggregates from silicone oil particles and air bubbles can be based on assumptions of particle morphology. That is, protein particles can appear to have irregular shapes, while oil and air particles can appear to be spherical. However, these methods can be considered invasive, can have large sample volume requirements, in certain instances the assumptions may not be correct, and at least in part because image clarity can depend on the contrast afforded by particle refractive index and diffraction limited optical resolution, particle assignment can be increasingly difficult for particles below a certain size, such as below about 5 microns.

Archimedes™ (e.g., Malvern) is a microfluidics device in which the buoyant masses of single particles can be sequentially and continuously measured in a flowing stream, which can yield a number vs. size distribution suitable to distinguish particles of protein vs. silicone oil vs. micro air bubbles. However, it can have a relatively large minimum detectable particle size, e.g., about 200 nm for proteins, and with channel dimensions of only 8 microns, shearing of even moderately sized subvisibles can occur. In addition, there can be a large extrapolation factor intrinsic to the method (due at least in part to small fractional sampling), which can reduce the accuracy of quantitating components present at low particle number concentration. As such, direct comparisons with the particle imaging methods can be difficult for samples with certain types of particles and particle size distributions.

Prefilled syringes can be used to package and deliver biopharmaceuticals, including where the dosage volume is less than about 1 mL, in a safe and sterile manner. Prefilled syringes can provide consistent delivery and dosing accuracy, and can be suitable for self-administration by patients. The invasive techniques described above, when used to evaluate prefilled syringes for quality control, can be unsuitable or impractical for evaluating more than a small fraction of syringes in a given manufacturing lot. Certain commercial noninvasive inspection systems for prefilled syringes are available, but they can generally be used to detect only the presence of high concentrations of very large particles (e.g., exceeding about 25 microns), and can be unable to discriminate between particle types.

U.S. Patent Application Publication No. 2013/0316934, which is incorporated by reference herein in its entirety, describes systems and techniques to noninvasively detect subvisible particles, including particles with a size sensitivity as low as about 0.1 microns, in prefilled syringes and other containers. However, there is an opportunity for improved systems and techniques to detect protein aggregates and other particles in prefilled syringes, including systems and techniques that can distinguish protein particles from other types of particles.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the drawings.

To achieve these and other advantages and in accordance with the purpose of the disclosed subject matter, as embodied and broadly described, the disclosed subject matter includes a method for inspecting particles in a liquid beneficial agent contained within a container. The method includes selectively illuminating at least a portion of a liquid beneficial agent contained within a container using an excitation beam configured to excite photoluminescent particles in the liquid beneficial agent to emit an emission light including an intrinsic photoluminescence of the photoluminescent particles and produce scattered excitation light, filtering the illuminated portion of the liquid beneficial agent to transmit the emission light and block the scattered excitation light, obtaining an image of the filtered emission light, analyzing image data representing the image of the filtered emission light to detect regions of the image representing the intrinsic photoluminescence of the photoluminescent particles, measuring an intensity of the regions of the image representing the intrinsic photoluminescence of the photoluminescent particles, determining a size or number of the photoluminescent particles from the measured intensity of the regions of the image representing the intrinsic photoluminescence of the photoluminescent particles, and rejecting the liquid beneficial agent if the size or number of the photoluminescent particles is above a predetermined threshold.

Additionally, and as embodied herein, the method can further include positioning an image detector orthogonally to the excitation beam. Alternatively, the method can further include positioning an image detector in line with the excitation beam. The image can be obtained using the image detector.

Furthermore, and as embodied herein, the emission light can be filtered using an optical filter disposed between the container and an image detector. The optical filter can be selected to isolate the intrinsic photoluminescence and block the scattered excitation light. The image detector can include a camera sensitive to UV or visible wavelengths. The camera can include a microscope lens corresponding to the UV or visible wavelengths.

In addition, and as embodied herein, the method can include determining a number or mass of photoluminescent monomers forming aggregate photoluminescent particles. The method can further include rejecting the liquid beneficial agent if the number or mass of the photoluminescent monomers forming the aggregate photoluminescent particles exceeds a threshold.

According to another aspect of the disclosed subject matter, systems for inspecting particles in a liquid beneficial agent contained within a container generally include a light source, an emission optical filter, an image detector and a data processor. The light source is configured to provide an excitation beam to illuminate at least a portion of a liquid beneficial agent contained within a container. The excitation beam is configured to excite photoluminescent particles in the liquid beneficial agent to emit an emission light including an intrinsic photoluminescence of the photoluminescent particles and produce scattered excitation light. The emission optical filter is in optical communication with the emission light and configured to filter the illuminated portion of the liquid beneficial agent by transmitting the emission light and blocking the scattered excitation light. The image detector is configured to obtain an image of the filtered emission light. The data processor is configured to receive image data representing the image from the image detector and is programmed to analyze the image data representing the image of the filtered emission light to detect regions of the image representing the intrinsic photoluminescence of the photoluminescent particles, measure an intensity of the regions of the image representing the intrinsic photoluminescence of the photoluminescent particles, determine a size or number of the photoluminescent particles from the measured intensity of the regions of the image representing the intrinsic photoluminescence of the photoluminescent particles, and reject the liquid beneficial agent if the size or number of the photoluminescent particles is above a predetermined threshold.

Additionally, and as embodied herein, the image detector can be positioned orthogonally to the excitation beam. Alternatively, image detector can be positioned in line with the excitation beam.

Furthermore, and as embodied herein, the image detector can include a camera sensitive to UV or visible wavelengths. The camera can include a microscope lens corresponding to the UV or visible wavelengths.

In addition, and as embodied herein, data processor can be configured to determine a number or mass of photoluminescent monomers forming aggregate photoluminescent particles. The data processor can be further configured to reject the liquid beneficial agent if the number or mass of the photoluminescent monomers forming the aggregate photoluminescent particles exceeds a threshold.

In accordance with another aspect of the disclosed subject matter herein, methods for inspecting particles in a liquid beneficial agent contained within a container generally include selectively illuminating at least a portion of a liquid beneficial agent contained within a container using an excitation beam configured to excite photoluminescent particles in the liquid beneficial agent to emit an emission light including an intrinsic photoluminescence of the photoluminescent particles, the illuminated portion of the liquid beneficial agent including the emission light and scattered excitation light including light scattered from the photoluminescent particles and light scattered from other particles, filtering the illuminated portion of the liquid beneficial agent using a first filter configured to block the emission light and transmit the scattered excitation light, obtaining a first image of the illuminated portion of the liquid beneficial agent from the first filter, filtering the illuminated portion of the liquid beneficial agent using a second filter configured to transmit the emission light and block the scattered excitation light, obtaining a second image of the illuminated portion of the liquid beneficial agent from the second filter, analyzing image data representing the first and second images of the illuminated portion of the liquid beneficial agent, using a data processor, to determine a size, number or total mass of the photoluminescent particles and a size, number or total mass of the other particles, and rejecting the liquid beneficial agent if the size, number, or total mass of the photoluminescent particles or the size, number or total mass of the other particles is above a predetermined threshold.

Additionally, and as embodied herein, the excitation beam can have a wavelength within a range of an excitation band of the photoluminescent particles and within a range of a transmission band of the container.

Furthermore, and as embodied herein, analyzing the image data can include determining a particle concentration and a total image intensity value from the image data representing the first image and determining a total particle intensity from the image data representing the second image. Additionally or alternatively, analyzing the image data can include determining a size, number or total mass of all particles in the liquid beneficial agent using the image data representing the first image and determining the size, number or total mass of the photoluminescent particles using the data representing the second image. As such, the size, number or total mass of the other particles can be determined as a difference between the size, number or total mass of all particles and the size, number or total mass of the photoluminescent particles.

In addition, and as embodied herein, the method can include rotating or translating the container relative the excitation beam to obtain first and second images of different regions of the liquid beneficial agent.

According to another aspect of the disclosed subject matter, systems for inspecting particles in a liquid beneficial agent contained within a container generally include a light source, a first optical filter, a second optical filter, an image detector and a data processor. The light source is configured to provide an excitation beam to selectively illuminate at least a portion of a liquid beneficial agent contained within a container. The excitation beam is configured to excite photoluminescent particles in the liquid beneficial agent and emit an emission light including an intrinsic photoluminescence of the photoluminescent particles and produce scattered excitation light including light scattered from the photoluminescent particles and light scattered from other particles. The first optical filter is configured to be disposed in optical communication with and filter the illuminated portion of the liquid beneficial agent by transmitting the emission light and blocking the scattered excitation light. The second optical filter configured to be disposed in optical communication with and filter the illuminated portion of the liquid beneficial agent by transmitting the emission light and blocking the scattered excitation light. The image detector is configured to be disposed in optical communication the first and second optical filters and obtain a first image of the illuminated portion of the liquid beneficial agent from the first filter and a second image of the illuminated portion of the liquid beneficial agent from the second filter. The data processor is configured to receive image data representing the first and second images from the image detector and programmed to analyze the image data representing the first and second images of the illuminated portion of the liquid beneficial agent, using a data processor, to determine a size, number or total mass of the photoluminescent particles and a size, number or total mass of the other particles, and reject the liquid beneficial agent if the size, number, or total mass of the photoluminescent particles or the size, number or total mass of the other particles is above a predetermined threshold.

Additionally, and as embodied herein, the excitation beam can have a wavelength within a range of an excitation band of the photoluminescent particles and within a range of a transmission band of the container.

Furthermore, and as embodied herein, the data processor can be further configured to analyze the image data by determining a particle concentration and a total image intensity value from the image data representing the first image and determining a total particle intensity from the image data representing the second image. Additionally or alternatively, the data processor can be further configured to analyze the image data by determining a size, number or total mass of all particles in the liquid beneficial agent using the image data representing the first image and determining the size, number or total mass of the photoluminescent particles using the data representing the second image. As such, the size, number or total mass of the other particles can be determined as a difference between the size, number or total mass of all particles and the size, number or total mass of the photoluminescent particles.

In addition, and as embodied herein, the system can further include a scanning device to rotate or translate the container relative the excitation beam to obtain first and second images of different regions of the liquid beneficial agent.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic diagram illustrating a representative system for inspecting particles in a liquid beneficial agent contained within a container implemented according to an illustrative embodiment of the disclosed subject matter.

FIG. 2 is a flow diagram illustrating a representative method for inspecting particles in a liquid beneficial agent contained within a container according to an illustrative embodiment of the disclosed subject matter.

FIG. 3 is a schematic diagram illustrating a representative system for inspecting particles in a liquid beneficial agent contained within a container implemented according to an alternative embodiment of the disclosed subject matter.

FIG. 4A is an exemplary intrinsic fluorescence image using the representative system of FIG. 1 according to the disclosed subject matter.

FIG. 4B is an exemplary intrinsic fluorescence image using the representative system of FIG. 3 according to the disclosed subject matter.

FIG. 5 is a diagram illustrating exemplary particle numbers per mL according to the disclosed subject matter.

FIGS. 6A and 6B each is a diagram illustrating exemplary excitation and emission spectra for purpose of illustration of the disclosed subject matter.

FIG. 7 is a schematic diagram illustrating another representative system for inspecting a liquid beneficial agent contained within a container implemented according to an illustrative embodiment of the disclosed subject matter.

FIG. 8 is a flow diagram illustrating another representative method for inspecting particles in a liquid beneficial agent contained within a container according to an illustrative embodiment of the disclosed subject matter.

FIG. 9A is an exemplary image obtained in a light scattering mode using the system of FIG. 7 according to the disclosed subject matter.

FIG. 9B is an exemplary image obtained in an intrinsic photoluminescence mode using the system of FIG. 7 according to the disclosed subject matter.

FIG. 10A is an exemplary image obtained in a light scattering mode using the system of FIG. 7 according to the disclosed subject matter.

FIG. 10B is an exemplary image obtained in an intrinsic photoluminescence mode using the system of FIG. 7 according to the disclosed subject matter.

FIG. 11 is a diagram illustrating an exemplary protein aggregate size distribution according to the disclosed subject matter.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The systems and methods presented herein can be used for detection of particles, such as proteins and protein aggregates or any other visible or subvisible particles, in any of a variety of suitable beneficial agents or substances. As used herein, a “liquid beneficial agent” or “beneficial agent” (used interchangeably herein) is intended to refer generally to a substance or formulation in liquid form to be administered to or used by an individual (also referred to herein as a user or a patient) for an approved medical indication, such as a medication, diagnostic, nutritional, or other therapeutic agent. For example and without limitation, the beneficial agent can include any protein or protein modified by chemical or genetic processes which is a candidate or precursor used to discover, optimize, or develop a drug candidate. The liquid beneficial agent can be a therapeutic solution, such as a therapeutic protein solution. Exemplary proteins can include abatacept, adalimumab, alefacept, erythropoietin, etanercept, infliximab, trastuzumab, ustekinumab, denileukin, diftitox, golimumab, other TNF, IL-12, or IL-23 antagonists, or any other suitable biological product.

The systems and methods described herein can be used to inspect particles in any container. For purpose of illustration of the disclosed subject matter, and not limitation, reference is made herein to a beneficial agent in a pre-filled syringe. As embodied herein, an exemplary container can include any container transparent to light at UV or visible wavelengths for excitation and detection of photoluminescence or scattered light. It is understood, however, that the systems and methods described herein can be used to inspect particles in any container, for example and without limitation, pre-filled devices, cartridges, cuvettes, flow cells or needle-free delivery systems, whether for medical use or for non-medical use. As embodied herein, the container can be an approved biologic drug delivery device, such as a syringe or cartridge, and the inspection systems and methods described herein can be considered “noninvasive” and non-destructive to the beneficial agent and delivery device.

For purpose of illustration and not limitation, particles in the liquid beneficial agent, such as protein monomers and aggregates thereof, can exhibit the intrinsic photoluminescence. The liquid beneficial agent can have an intrinsic “photoluminescence.” As embodied herein, “photoluminescence” (including but not limited to that of a protein or beneficial agent) can include light elicited by excitation at a UV or visible wavelength of light. For example and without limitation, photoluminescence can include fluorescence, phosphorescence, or any emissive process detectable at a wavelength different from the excitation wavelength. The photoluminescence can be described as “intrinsic,” which can refer to the source of the UV or visible wavelength emission arising from the molecular structure of the beneficial agent (including but not limited to monomers and/or aggregates thereof).

For purpose of illustration and not limitation, and as embodied herein, “photoluminescent particles” can include protein aggregates and protein monomers of the beneficial agent. A protein monomer can be a molecular monomer. A protein aggregate can be an integral multiple of a protein monomer, which can be, for example and without limitation, a dimer or larger. For example and without limitation, in proteins, aromatic amino acid residues, such as tryptophan, tyrosine, and phenylalanine, can exhibit characteristic absorption bands between about 250-310 nm. Excitation in this region generates near UV fluorescence (e.g., about 270-400 nm), and tryptophan can be the greatest source of emission. U.S. Pat. No. 7,545,495, which is incorporated by reference herein in its entirety, discloses exemplary methods and systems for discriminating protein crystals from salt or small molecule crystals, including utilizing both UV absorption and UV fluorescence modalities.

For purpose of illustration and not limitation, and as embodied herein, “other particles” can refer to any discrete, non-photoluminescent particles resolved in the image obtained by light scattering at the excitation wavelength. For example and without limitation, other particles can include lubricant particles (such as silicone oil), air bubbles or other foreign particles.

In accordance with the disclosed subject matter herein, methods for inspecting particles in a liquid beneficial agent contained within a container generally include selectively illuminating at least a portion of a liquid beneficial agent contained within a container using an excitation beam configured to excite photoluminescent particles in the liquid beneficial agent to emit an emission light including an intrinsic photoluminescence of the photoluminescent particles and produce scattered excitation light, filtering the illuminated portion of the liquid beneficial agent to transmit the emission light and block the scattered excitation light, obtaining an image of the filtered emission light, analyzing image data representing the image of the filtered emission light to detect regions of the image representing the intrinsic photoluminescence of the photoluminescent particles, measuring an intensity of the regions of the image representing the intrinsic photoluminescence of the photoluminescent particles, determining a size or number of the photoluminescent particles from the measured intensity of the regions of the image representing the intrinsic photoluminescence of the photoluminescent particles, and rejecting the liquid beneficial agent if the size or number of the photoluminescent particles is above a predetermined threshold.

According to another aspect of the disclosed subject matter, systems for inspecting particles in a liquid beneficial agent contained within a container generally include a light source, an emission optical filter, an image detector and a data processor. The light source is configured to provide an excitation beam to illuminate at least a portion of a liquid beneficial agent contained within a container. The excitation beam is configured to excite photoluminescent particles in the liquid beneficial agent to emit an emission light including an intrinsic photoluminescence of the photoluminescent particles and produce scattered excitation light. The emission optical filter is in optical communication with the emission light and configured to filter the illuminated portion of the liquid beneficial agent by transmitting the emission light and blocking the scattered excitation light. The image detector is configured to obtain an image of the filtered emission light. The data processor is configured to receive image data representing the image from the image detector and is programmed to analyze the image data representing the image of the filtered emission light to detect regions of the image representing the intrinsic photoluminescence of the photoluminescent particles, measure an intensity of the regions of the image representing the intrinsic photoluminescence of the photoluminescent particles, determine a size or number of the photoluminescent particles from the measured intensity of the regions of the image representing the intrinsic photoluminescence of the photoluminescent particles, and reject the liquid beneficial agent if the size or number of the photoluminescent particles is above a predetermined threshold.

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, exemplary embodiments of systems and methods for inspecting a liquid beneficial agent contained within a container in accordance with the disclosed subject matter are shown and described below.

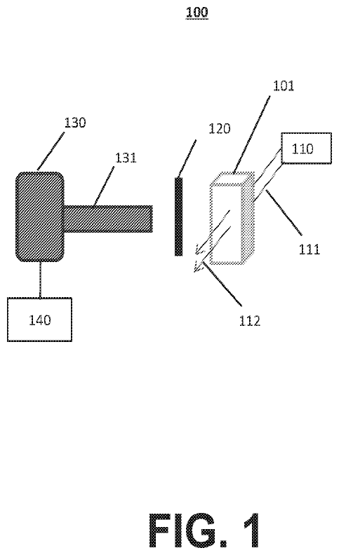

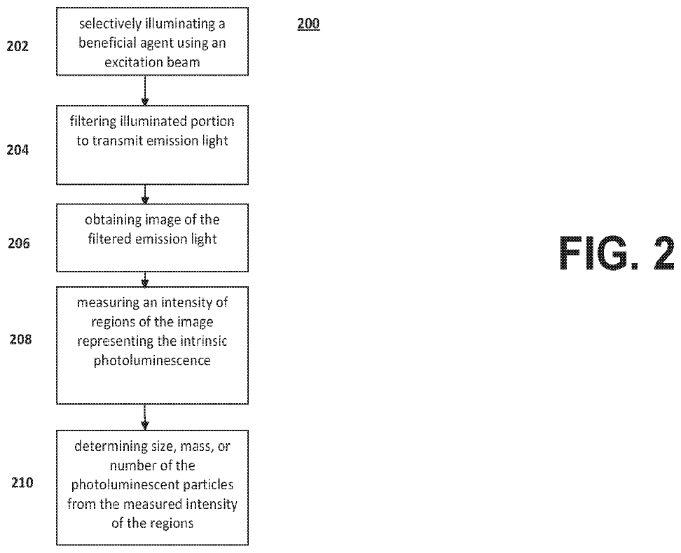

According to aspects of the disclosed subject matter, systems and methods for inspecting particles in a liquid beneficial agent contained within a container can provide characterization of protein monomers and aggregates thereof using protein intrinsic UV fluorescence imaging. With reference to the exemplary system 100 of FIG. 1, in conjunction with the exemplary method 200 of FIG. 2, the exemplary container 101 can be a UV-transparent container, such as a UV transparent cuvette (e.g., a quartz cuvette), configured to hold the protein solution. At 202, a light source 110 provides an excitation beam 111, which as embodied herein can be a UV excitation beam, to illuminate the contents from one side of the container 101. At 204, an optical filter 120, which as embodied herein can be configured as a long pass optical filter, can filter the resulting illumination beam 112 to block contributions from scattered excitation light. As such, at 206, an image detector 130 can obtain an image of the resulting fluorescence of all protein entities. For example and as embodied herein, the image detector 130 can be configured as a UV sensitive camera positioned orthogonally to the excitation beam. A microscope lens can serve as the camera lens 131. Alternatively, as described herein, the exemplary container 101 can be transparent at visible wavelengths, and the excitation beam 111 can be provided by the light source 110 at a visible wavelength. As such, as embodied herein, an exemplary image detector 130 can be a camera sensitive to the wavelength range (whether UV or visible), and can be used for photoluminescence and/or scattered light modalities, as described further herein.

The container 101 selected for use with the system 100 can be configured to have cross-sectional dimensions such that the pathlengths for orthogonal excitation and emission axes allow adequate transmission and signal to noise corresponding to the optical density of the sample solution at the excitation and emission wavelengths utilized. For example and without limitation, the container 101 can be a fluorescence cell, and as embodied herein, can have internal square or rectangular cross dimensions within a range of about 1 to 10 mm.

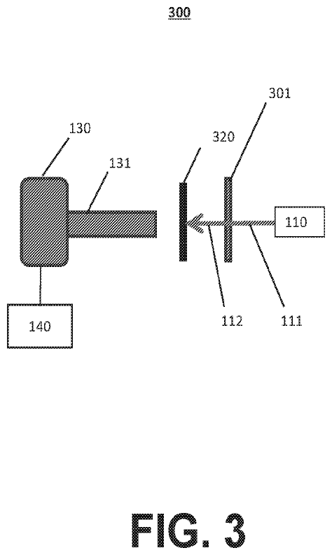

With reference to FIG. 3, an alternative embodiment of a system 300 for inspecting particles includes a container 301 configured as a UV transparent micro flow cell or cuvette with an appropriately chosen short path length (for example and without limitation, embodied herein as about 50 microns), and as such, a straight-through, front illumination geometry is utilized. In this manner, system 300 can be better suited for investigating high-concentration protein solutions or solutions having a very high net optical density at the excitation wavelength. However, each system 100, 300 can be used with samples at dilute protein concentrations. For purpose of illustration and comparison, and not limitation, the optical attenuation specifications for the optical filter 320 in system 300 can be more demanding due at least in part to the straight-through geometry, and thus can involve a higher suppression of light at the excitation wavelength. In addition, low autofluorescence of the optical filter 320 can be an optical quality attribute affecting the performance of system 300 when imaging low protein concentrations, however, system 100 is also suitable for such samples.

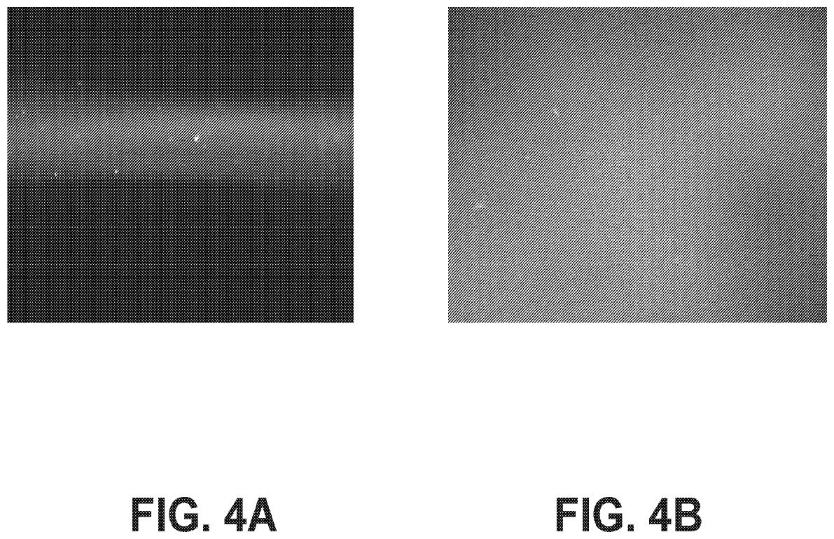

At 208 of FIG. 2, using systems 100 or 300, an intensity of regions of the image representing the intrinsic photoluminescence is measured. For purpose of illustration and confirmation of the disclosed subject matter, and not limitation, an exemplary protein solution (embodied herein as BSA, less than 1 mg/mL) was used to test the optical formats of systems 100 and 300 described herein. With reference to FIGS. 4A and 4B, images based on intrinsic protein fluorescence were obtained using systems 100 and 300, respectively, with the same sample contents. As embodied herein, the contents were illuminated with a light source 110 having an excitation wavelength of 280 nm and the image obtained with a camera 130 having a field of view of 0.7 mm×0.7 mm.

In each of FIGS. 4A and 4B, protein aggregates can be seen as discrete bright spots of fluorescence against a continuous white background of fluorescence. The latter (due at least in part to protein monomers) exhibits some non-uniform areas of intensity, which can be caused by the optical specifications of the LED light source used herein; these non-uniform areas of intensity can be reduced or minimized by employing a high quality UV laser. For purpose of illustration and comparison, as embodied herein, detection is fluorescence-based, and thus the minimum detectable particle size is not diffraction limited, in contrast to certain imaging methodologies, which can be affected by the resolution of single particle morphology.

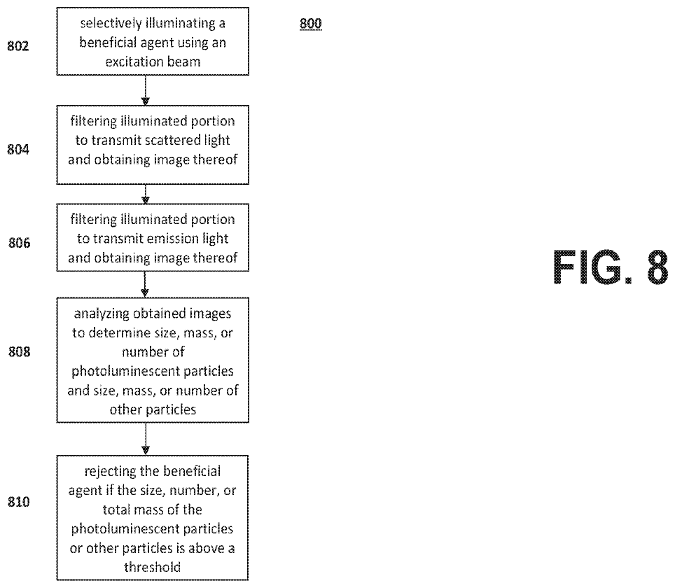

At 210 of FIG. 2, using systems 100 or 300, a particle mass, size or number can be determined by the fluorescence intensity of the fluorescent spots, which can be calibrated by the fluorescence of monomers at known concentrations. Fluorescence-based imaging can have a very high sensitivity, which can be affected by the signal-to-noise ratio of the optical system. Protein particles with dimensions spanning submicron (for example and without limitation, as low as 100 nm or less) to “subvisible” (for example and without limitation, about 1-100 microns) sizes and larger can be detected in a single measurement. As such, systems 100 and 300 can be used, for example and without limitation, for formulation development, where protein aggregates can be detected at both dilute and high concentrations, and without changing formulation solvent composition. Additional features of measuring intensity of fluorescent regions and determining a particle mass, size or number by the fluorescence intensity are described below with respect to 808 of FIG. 8.

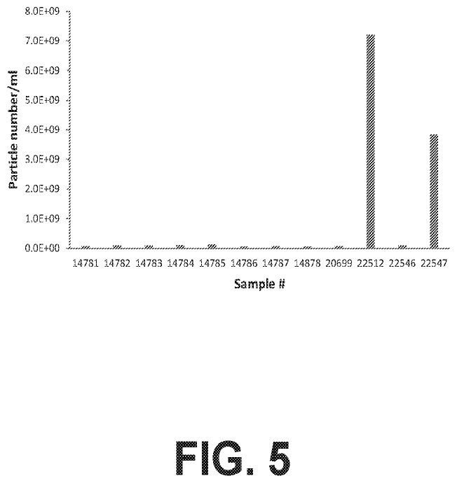

With reference to FIG. 5, protein particle densities determined from 12 samples (as embodied herein, illuminated with an excitation wavelength of 280 nm) in accordance with the disclosed subject matter is illustrated. In this example, “particles” are defined as aggregates down to a particle size of about 100 nm. As such, in FIG. 5, for purpose of illustration and confirmation of the disclosed subject matter, exemplary results are shown according to the disclosed subject matter using system 100 on twelve early stage biologic macromolecules at dilute concentrations. As embodied herein, each sample was imaged at a concentration of about 20 mg/mL. The samples each include relatively large amounts of protein aggregates, and as shown in FIG. 5, samples identified as #22512 and #22547 each is heavily aggregated relative the other samples. These results were additionally confirmed by comparing the concentration changes of these samples before and after ultracentrifugation using conventional techniques (data not shown).

Systems and methods described herein can provide noninvasive detection of protein aggregates in prefilled syringes. The prefilled syringes can be configured to contain any suitable volume, for example 0.01 to 1.0 mL, 1.1 to 2.5 mL, or 2.6 to 5.0 mL. For a noninvasive inspection system for prefilled syringes, potential challenges can arise. For example and without limitation, under excitation at UV wavelengths below about 300 nm, which can be utilized for protein intrinsic fluorescence, penetration of the excitation light into the solution can be poor at high protein concentrations of biologics, due at least in part to the high optical density. Selection of an excitation wavelength off the absorption peak can be unsuitable at least in part because certain syringes and containers are not transparent in this wavelength region. Potential UV photochemical damage to proteins can also present a challenge.

Visible wavelength fluorescence (e.g., longer than about 400 nm) can be observed from protein crystals and the surrounding solution, which can contain a mixture of monomers, oligomers, and particulates, when excited in the near visible region (e.g., within a range of about 340-450 nm). Apparent visible wavelength emissions can be observed from proteins in a solution, as well as from crystals and amorphous solids. The inducible visible fluorescence in proteins can occur from a source or combination sources including, but not limited to, oxidized chemical groups, beta sheet structures, and/or delocalized peptide chain electrons. The inducible visible fluorescence can thus be observed from protein monomers and protein aggregates in a solution.

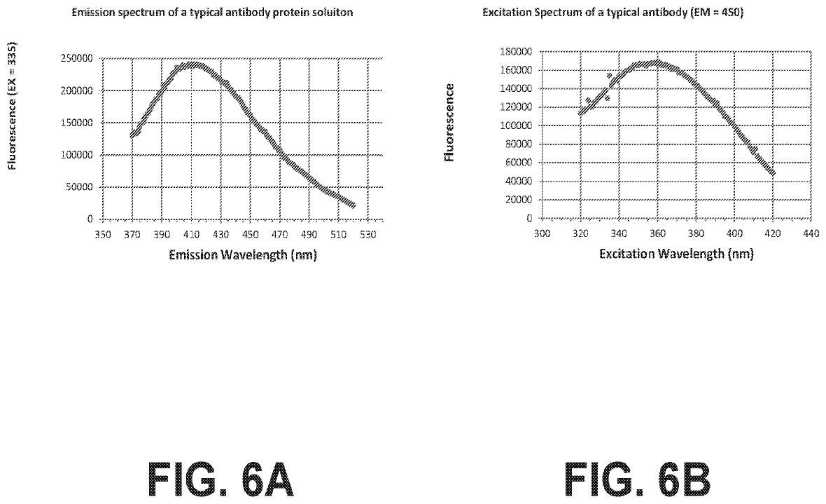

Antibodies can contain many intramolecular beta sheet structures, and this type of intrinsic visible fluorescence can be excited not only in aggregates, but from antibody monomers as well. For purpose of illustration and confirmation of the disclosed subject matter, fluorescence of a highly purified monoclonal antibody can be analyzed, and the homogeneity can independently confirmed by analytical, biochemical, and biophysical tools. The excitation and emission spectra of an exemplary antibody is shown, for purpose of illustration and not limitation, in FIGS. 6A and 6B, respectively, as measured using a conventional scanning fluorescence spectrometer. As shown in FIGS. 6A and 6B, the excitation and emission spectra of the exemplary antibody each is broad. The optical extinction coefficient is relatively weak (as embodied herein, in the 320-420 nm region), and as such, direct excitation of concentrated protein solutions can be performed. By exciting in this region, potential photochemical damage to proteins can be reduced, and syringes and other delivery containers used for biologics are generally transparent at these wavelengths.

In accordance with another aspect of the disclosed subject matter herein, methods for inspecting particles in a liquid beneficial agent contained within a container generally include selectively illuminating at least a portion of a liquid beneficial agent contained within a container using an excitation beam configured to excite photoluminescent particles in the liquid beneficial agent to emit an emission light including an intrinsic photoluminescence of the photoluminescent particles, the illuminated portion of the liquid beneficial agent including the emission light and scattered excitation light including light scattered from the photoluminescent particles and light scattered from other particles, filtering the illuminated portion of the liquid beneficial agent using a first filter configured to block the emission light and transmit the scattered excitation light, obtaining a first image of the illuminated portion of the liquid beneficial agent from the first filter, filtering the illuminated portion of the liquid beneficial agent using a second filter configured to transmit the emission light and block the scattered excitation light, obtaining a second image of the illuminated portion of the liquid beneficial agent from the second filter, analyzing image data representing the first and second images of the illuminated portion of the liquid beneficial agent, using a data processor, to determine a size, number or total mass of the photoluminescent particles and a size, number or total mass of the other particles, and rejecting the liquid beneficial agent if the size, number, or total mass of the photoluminescent particles or the size, number or total mass of the other particles is above a predetermined threshold.

According to another aspect of the disclosed subject matter, systems for inspecting particles in a liquid beneficial agent contained within a container generally include a light source, a first optical filter, a second optical filter, an image detector and a data processor. The light source is configured to provide an excitation beam to selectively illuminate at least a portion of a liquid beneficial agent contained within a container. The excitation beam is configured to excite photoluminescent particles in the liquid beneficial agent and emit an emission light including an intrinsic photoluminescence of the photoluminescent particles and produce scattered excitation light including light scattered from the photoluminescent particles and light scattered from other particles. The first optical filter is configured to be disposed in optical communication with and filter the illuminated portion of the liquid beneficial agent by transmitting the emission light and blocking the scattered excitation light. The second optical filter configured to be disposed in optical communication with and filter the illuminated portion of the liquid beneficial agent by transmitting the emission light and blocking the scattered excitation light. The image detector is configured to be disposed in optical communication the first and second optical filters and obtain a first image of the illuminated portion of the liquid beneficial agent from the first filter and a second image of the illuminated portion of the liquid beneficial agent from the second filter. The data processor is configured to receive image data representing the first and second images from the image detector and programmed to analyze the image data representing the first and second images of the illuminated portion of the liquid beneficial agent, using a data processor, to determine a size, number or total mass of the photoluminescent particles and a size, number or total mass of the other particles, and reject the liquid beneficial agent if the size, number, or total mass of the photoluminescent particles or the size, number or total mass of the other particles is above a predetermined threshold.

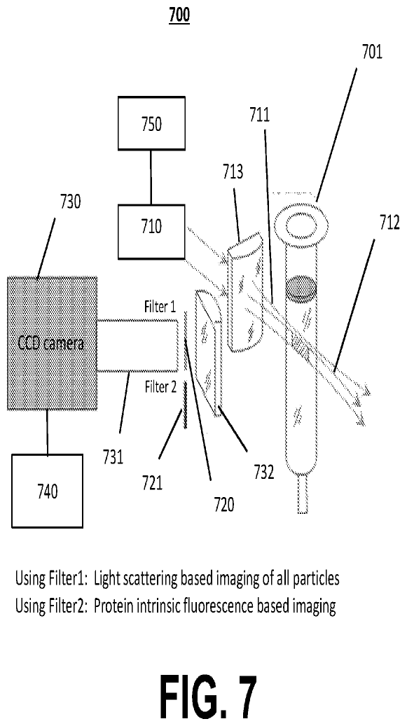

An exemplary Noninvasive Subvisible Particle Detection (“NSPD”) system is described in U.S. Patent Application Publication No. 2013/0316934, which is incorporated by reference herein in its entirety, including the use of light scattering-based imaging for detecting and counting particles nondestructively in prefilled syringes. The systems and techniques of the disclosed subject matter using intrinsic fluorescence-based imaging can also provide for the identification of the protein aggregate subset of all particles. By integrating the two approaches of light scattering-based imaging and intrinsic fluorescence-based imaging into a single system (referred to herein as “NSPD-2”), both total particles and protein aggregates can be evaluated noninvasively in prefilled syringes. Alternatively, either of the approaches can be performed separately, for example using separate systems. The schematic design of an exemplary NSPD-2 system 700 is shown in FIG. 7, in conjunction with the exemplary method of FIG. 8.

With reference to FIG. 7, and as embodied herein, system 700 has two detection modes. A first mode is the light scattering-based imaging mode, which records all particles. The second mode is the intrinsic fluorescence-based imaging mode, which records protein particles. For example and as embodied herein, and without limitation, the same light source 710 can be used for both modes, while maintaining similar optical geometries and regions in the solution being interrogated.

Certain additional steps, such as calibrating an image detector to a desired sensitivity, can be performed initially and/or periodically, and repeated when each new type of beneficial agent is to be evaluated. Additional adjustments to the system can include the position of the image detector, the position or configuration of optical elements, the wavelength, intensity, or position of the light source, or other applicable parameters described herein. By contrast, some steps can be performed for each beneficial agent container to be tested, such as physically placing the beneficial agent container into alignment with a light source and an image detector. When the steps to prepare the device and beneficial agent container for analysis are completed, a signal can be provided to the device or to the user to indicate that the system is ready for testing.

At 802 of FIG. 8, at least a portion of the beneficial agent in container 701 is selectively illuminated. If desired, the entire contents of the container 701 can be analyzed. Illuminating the beneficial agent can include directing light source 710 at the portion of the container 701 containing the beneficial agent to be analyzed.

In accordance with one aspect of the disclosed subject matter, the beneficial agent is illuminated by a thin sheet of illumination. The thin sheet of illumination can be formed by the light source 710, alone or in combination with an optical element, such as lens 713. Forming a thin sheet of illumination in the beneficial agent can create a substantially planar field of light observable by an image detector, and can enhance contrast of an image obtained of the beneficial agent in the area of the thin sheet of illumination. Enhanced contrast of the image can allow for imaging of particles of submicron dimensions, including detecting particles much smaller than the wavelength of light, using the image analysis techniques described below. Selectively illuminating the beneficial agent can include focusing light through an optical element, such as lens 713 corresponding to the container. That is, lens 713, embodied herein as a cylindrical lens, can be provided between light source 710 and container 701 to form the thin sheet of illumination, as well as operate in concert with container 701 and image detector 730 to eliminate distortion caused by the curvature of the syringe wall. For example, the beneficial agent container 701 can have a curvature that distorts the focus of the light through the container 701. An optical element, such as lens 713, having a curvature corresponding to the curvature of the container can be introduced between the light source 710 and the container 701 to offset the curvature of the container 701 and better focus the light through the container 701 and to form a thin sheet of illumination within the container 701.

The light source 710 can be any suitable light source to illuminate the container. For example and without limitation, the light source 710 can be a coherent light source, such as a laser. The light source 710 can be selected to produce light having a particular wavelength. For example and without limitation, the light source can provide light having a wavelength suitable for both exciting an intrinsic fluorescence of a beneficial agent as well as to allow for light scattering by the particles, each of which can then be imaged as described herein. As such, the same excitation beam can be used for both modes of detection and imaging, i.e. light scattering-based imaging and intrinsic fluorescence-based imaging. By illuminating with the same beam, regions of beneficial agent within the container can have similar geometry and volume, which can improve accuracy of making comparisons of particles detected in each mode. As such, the excitation beam, in addition to being within the excitation band of the photoluminescent particles, can also be within the transmission band of the container, to allow for the excitation beam to penetrate the container and scattering light from particles in the liquid beneficial agent. Hence, the wavelength chosen for the excitation beam can depend on the excitation characteristics of the photoluminescent particles in the liquid beneficial agent, as well as the optical transmission characteristics of the container.

At 804 of FIG. 8, the illuminated portion of the liquid beneficial agent is filtered using optical filter 720 configured to block the emission light and transmit the scattered excitation light, as described herein, and an image of the illuminated portion through optical filter 720 is obtained. For purpose of illustration, and not limitation, the optical filter 720 can be configured as a band pass filter having a pass band at the wavelength of the excitation beam. In this manner, the image obtained can be due to light scattering from particles in the illuminated portion of the beneficial agent, while excluding any contribution of intrinsic photoluminescence to the scattered light signal. Additionally, the optical filter 720 can be selected to be of a sufficient quality to not exhibit “autofluorescence” itself when receiving scattered light from the excitation beam and/or intrinsic fluorescence emitted by the photoluminescent particles.

Obtaining an image can include sending a signal to the image detector 730 to capture the image. In some cases, such as if a new type of beneficial agent and/or container is being tested or if the configuration of the detection system has been changed, the image detector 730 can first be calibrated to a predetermined sensitivity and/or with a baseline product of a known quality level. Obtaining an image can include focusing the image at the image detector through an optical element, such as lens 732, corresponding to the container. For example, the beneficial agent container 701 can have a curvature that distorts the focus of the image detector 730 through the container 701. Hence, and as previously noted, an optical element, such as lens 732, having a curvature corresponding to the curvature of the container 701 can be introduced between the image detector 730 and the container 701 to offset the curvature of the container 701 and provide an image that is substantially free of distortion from the curvature of the container 701. Further, an optical element, such as a microscope objective lens 731, optically coupled with the image detector 730, can be used to obtain an image of the beneficial agent with increased resolution. Increased resolution of the image can allow detection of particles in the beneficial agent using the image analysis techniques described herein.

For example and without limitation, reference is made to performing the detection method by obtaining a single, still-frame image of the liquid beneficial agent in light scattering mode. However, it will be understood that the detection method can be performed by taking a series of still-frame images, a motion video image or photodetector signal of the liquid beneficial agent over a period of time if dynamic analysis is desired. Additionally, while the detection method can be performed using an image of only a select portion of the liquid beneficial agent, the method can likewise be applied to or across the entire contents of the container 701. For example, the container 701 can be translated across a fixed light in multiple steps to obtain multiple images of the liquid beneficial agent, and/or the light from the light source 710 can be redirected across selected portions of the container to obtain corresponding images. System 700 can thus optionally include a scanning device 750 to select different regions of the solution to be inspected, and thus allow analysis of different regions of the liquid beneficial agent inside the container, as described further herein. For example and without limitation, and as embodied herein, the scanning device 750 can include a motorized stage to rotate the syringe and/or move the syringe to different positions along its longitudinal axis. However, reducing the number of image frames obtained and/or reducing the size of the portion of the container to be imaged can increase the throughput, i.e., the number of containers that can be tested in a given time. Hence, high-throughput detection can be performed by utilizing a single frame image of only a portion of the liquid beneficial agent.

At 806 of FIG. 8, the illuminated portion of the liquid beneficial agent is filtered using optical filter 721 configured to transmit the emission light and block the scattered excitation light, as described herein, and an image of the illuminated portion through optical filter 721 is obtained. In certain beneficial agents, for example biologic protein drugs, excitation of intrinsic protein fluorescence due to natural, unmodified amino acids in the beneficial agent can be achieved by illumination of the beneficial agent with light having a wavelength within an absorption band. For example, a wavelength within an absorption band can be within a range of about 200 nm to about 330 nm for certain proteins. Excitation of the beneficial agent can cause the beneficial agent to emit fluorescence having an emission wavelength, as described herein. Other beneficial agents, such as small molecule drugs that are intrinsically fluorescent, can be excited at substantially any suitable ultraviolet, visible, or near-infrared wavelength. Hence, an image of the intrinsic fluorescence from the excitation of the beneficial agent can be obtained by placing an optical filter having a transmission region corresponding to the emission wavelength of the beneficial agent within the view of the image detector. Additionally, light scattering from the excitation beam can be blocked by excluding the wavelength of the excitation beam from the transmission region of the optical filter. The intrinsic fluorescence image can be obtained as described herein, e.g., as described with respect to 804 above.

At 808 of FIG. 8, the images obtained at 804 and 806 are processed to determine certain characteristics of the images, from which characteristics of the liquid beneficial agent under investigation can be determined. Exemplary image analysis for the image obtained using the light scattering imaging mode is described in U.S. Patent Application Publication No. 2013/0316934, which is incorporated by reference herein in its entirety. As embodied herein, two or more image processing techniques are performed independently or in combination on the single image obtained from light scattering. Combining the two or more image processing techniques thus increases the range and accuracy of particle sizes that can be detected using the detection method. For example and without limitation, and as embodied herein, particles of about 25 nm or greater can be directly identified in the image, and one skilled in the art will recognize that other sizes of particles can be imaged based at least in part on the optical conditions of the system and/or the type of sample being imaged.

The direct imaging technique, such as nanoparticle imaging or other suitable technique, can be performed on the light scattering image of the beneficial agent. Direct imaging can be used to obtain a particle concentration. For example and without limitation, the image can be evaluated by counting a number of particles exceeding a size threshold or an intensity threshold to determine a particle concentration. Counting the number of particles exceeding the size threshold or the intensity threshold can be performed using a number of known techniques. For example, particle scattering intensities can be used to estimate particle mass. A particle intensity distribution thus can be generated by identifying the number of particles exceeding a certain predetermined particle scattering intensity and plotting the number of particles over the corresponding image area to obtain a particle concentration. Alternatively, if the number of particles that exceed a predetermined size or intensity is known, then plotting is not required. A variety of suitable algorithms for direct imaging can be used to analyze an image and obtain the particle concentration. For example and without limitation, currently-available software, such as ImageJ, can be utilized to perform these functions. Various tools available through ImageJ, such as “Maximum,” “Analyze Particle,” and “Histogram,” or other suitable software tools can be used to perform particle identification, particle counting, measuring image intensity distributions or the like. Additional tools and software likewise can be used and/or be adapted according to the intended implementation. Accordingly, as will be discussed below, whether and how many particles identified in the light scattering image exceed the particle concentration can be used as a factor to determine the quality of the beneficial agent.

The total particle number in a container (Nₜₒₜₐₗ) can be determined by the relation,

$${N}_{total} = \frac{{N}_{per \_ image} {V}_{total}}{{V}_{detection}} , \qquad ( 1 )$$

where N_{per_image} represents the total number of particles in the image, Vₜₒₜₐₗ represents the total volume of the container and V_{detection} represents the volume imaged in a single image.

A user can establish a threshold of particle concentration based on a desired quality of a particular sample to be measured. A sample having a particle concentration exceeding the threshold can be determined to be “unacceptable,” and thus no further testing of the unacceptable sample need be performed. A sample having a particle concentration that does not exceed the threshold can be subjected to further analysis by determining a total image intensity, from which an average molecular weight can be determined, as described herein. As such, the presence of very small aggregates or particles (for example and as embodied herein, less than about 100 nm), which can be too small to be imaged as discrete particles and thus too small to be counted by particle counting, can still be detected by the subsequent technique.

Separately, a total image intensity analysis can be performed on the light scattering-based image to determine a total image intensity, from which an average molecular mass of particles in the beneficial agent can be determined. The total image intensity analysis can be based on static light scattering (SLS), which can be considered as an indirect imaging technique, and can allow for detection of particles as small as about 10 nm or less. SLS-based indirect imaging can include measuring an image intensity value of the image data. The total image intensity value can be measured, for example, by determining or obtaining a pixel intensity value of each pixel representing the image, or a region of the image of interest, and combining the pixel intensity values obtained to determine the total image intensity value. The total image intensity value can be divided by the number of pixels to obtain an average image intensity value for the image. A variety of suitable algorithms can be used to measure an image intensity value from image data. For example and without limitation, currently-available software, such as ImageJ by the National Institutes of Health described above, can be used to perform these functions. The image intensity value can be considered to be proportional to the average molecular mass and particle concentration of the particles, including molecules, in the measured region, offset by a background intensity. Furthermore, the total image intensity can be determined by measuring an intensity of each pixel in an image, for example by using ImageJ or similar software.

Based upon the above, the image intensity value and particle concentration can be used to determine an average molecular weight of all particles in the sample, and as such can be used as a factor to determine the quality of the beneficial agent. For example, and for purpose of understanding and not limitation, under Rayleigh scattering conditions, the image intensity value (I_{Total}) can be considered linearly proportional to the average molecular weight (M_{W}) and concentration (C), offset by a background intensity (I_{background}), as represented by,

I_{Total}=B_{constant}M_{w}C+I_{background}. (2)

As such, with a sample including a protein of known molecular weight and independently determined concentration, the instrument constant (B_{constant}) can be determined, and the system can be calibrated for average molecular weight detection using eq. (2) above. The background intensity can be measured with a baseline solution, for example a solution of pure water or buffer without protein. Further details of static light scattering techniques to characterize molecules, and related aspects of physical chemistry as known in the art, can be relied upon for further understanding and modification of the disclosed subject matter.

Additionally, as embodied herein, the image obtained using intrinsic fluorescence-based imaging can be analyzed using the techniques described herein. For example and without limitation, at 808 of FIG. 8, (and at 208 and 210 of FIG. 2), the image obtained using intrinsic fluorescence-based imaging can be analyzed to measure an intensity of regions of the image representing the intrinsic photoluminescence, and a size, mass or number of the photoluminescent particles can be determined from the measured intensity of the regions, as described further below.

For purpose of illustration of the disclosed subject matter, and not limitation, a solution including polystyrene particles with independently known particle number concentration and size (embodied herein about 200 nm in diameter) was used to calibrate the light scattering detection volume of the system as described in U.S. Patent Application Publication No. 2013/0316934, which is incorporated by reference herein in its entirety. Since each of the imaging modes of system 700 can share similar optical configurations with the exception of the filter in the viewing arm of the system, the imaging modes can share similar solution interrogation volumes. Based on this calibration, the number of particles in one image frame can be used to calculate the particle density (e.g., particle number/mL) of the solution. The thickness of the light sheet (as embodied herein, 0.028 mm) of the exemplary system can also be deduced using the size of the field of view (as embodied herein, 1.5×1.5 mm). Fluorescence intensity generally has a linear relationship with molecular number, and as such, the masses (or sizes) of protein aggregates can be estimated from their intensities. The total aggregated mass can thus be calculated from the total particle intensity, for example using the following relationships:

I_{aggregate}=N_{aggregation number}Iₘₒₙₒₘₑᵣ (3)

Mass_{aggregate}=N_{aggregation number}Massₘₒₙₒₘₑᵣ (4)

where I_{aggregate} and can Iₘₒₙₒₘₑᵣ can represent the fluorescence intensity of aggregates and monomers, respectively, N_{aggregation number} can represent the molecular number of aggregates, and Mass_{aggregate} and Massₘₒₙₒₘₑᵣ can represent the mass of an aggregate and the mass of a monomer, respectively.

For example, and as embodied herein, the image detection volume in system 700 can be low (about 63 nL), and thus calculating total or protein particle number concentration by extrapolating from a single image can be difficult to obtain an average particle distribution representative of the total syringe contents, particularly at low particle numbers. To improve accuracy, scanning system 750 can continuously collect images from many physical locations within the drug solution by rotation and translation of syringe position. Image acquisition and analysis software can be used to record and analyze images in real time during the scanning. For example and without limitation, images can be recorded and analyzed using an analytical software tool, such as MATLAB® (MathWorks). For purpose of illustration, and not limitation, as embodied herein, the exemplary system can acquire and analyze 100 images within approximately 90 seconds.

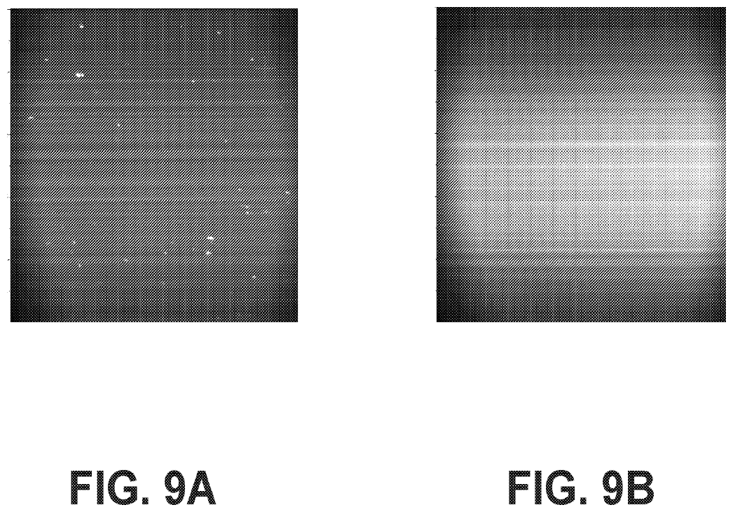

For purpose of illustration and confirmation of the disclosed subject matter, system 700 was tested with syringes filled with exemplary protein solutions. FIGS. 9A and 9B are images taken after a syringe filled with a highly monomeric protein solution was vortexed. FIG. 9A was obtained using light scattering mode, and FIG. 9B was obtained using intrinsic fluorescence mode, each illuminated using a light source having a wavelength of 360 nm and imaged with a field of view of 1.5 mm×1.5 mm. Resulting micro-air bubbles and silicone oil droplets can be seen in the light scattering mode (FIG. 9A). By comparison, these same particles are invisible by imaging in the fluorescence mode (FIG. 9B). The mild treatment does not generate significant protein aggregates.

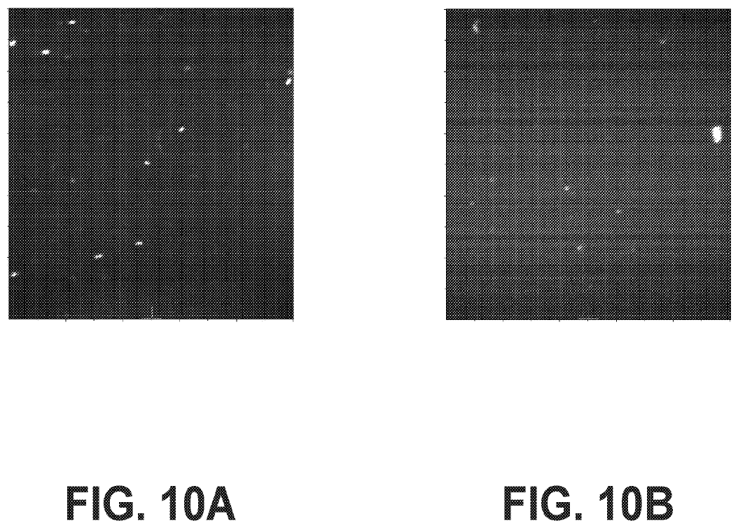

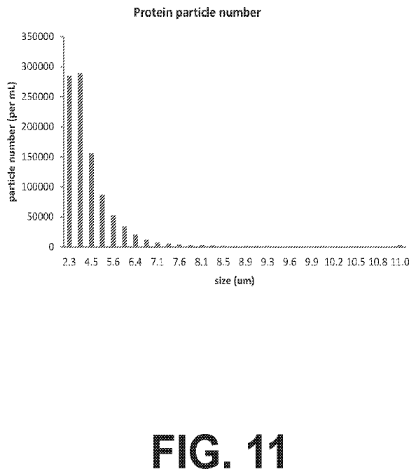

In another example, for purpose of illustration and confirmation of the disclosed subject matter, FIGS. 10A and 10B are images obtained from a pre-filled syringe filled with a sample which was mechanically stressed to generate protein aggregates from a monomeric sample. The syringe was inverted 10 times before measurement to improve the average physical homogeneity of particles located throughout the syringe volume. 100 images were taken from this syringe; representative images taken in light scattering mode and fluorescence mode are shown in FIGS. 10A and 10B, respectively, each illuminated using a light source having a wavelength of 360 nm and imaged with a field of view of 1.5 mm×1.5 mm. After image analysis, the total number of particles was determined to be larger than the number of protein specific particles. This is due at least in part because the total particle number includes all proteinaceous and non-proteinaceous particles. An analysis of protein particle size distribution (based on the calibration mentioned above, and a spherical particle approximation) is shown in FIG. 11. By comparing the total fluorescence intensity (which, as embodied herein, includes all protein species) with the total particle fluorescence intensity, the aggregated mass in this syringe can be estimated to be about 49 micrograms (as embodied herein about 0.12% of total protein) for this syringe, which can be considered to be heavily aggregated.

At 810 of FIG. 8, the results of the image processing techniques performed on the light scattering image and the intrinsic fluorescence image in 808 are evaluated to determine a quality level of the liquid beneficial agent. The determination of the quality level can be based independently on each of the results obtained by the image processing techniques performed in 808. For example, the particle concentration obtained from the light scattering-based direct imaging technique can be compared to a particle concentration threshold. If the particle concentration exceeds the particle concentration threshold, the quality of the liquid beneficial agent can be considered to be unacceptable, and a warning can be generated that the liquid beneficial agent has failed the inspection (at 810).

Separately, the image intensity value (total or average) measured using the light scattering-based indirect imaging technique can be compared to an image intensity threshold. If the image intensity value exceeds the image intensity threshold, then the quality of the liquid beneficial agent can be considered to be unacceptable, and a warning can be generated that the liquid beneficial agent has failed the inspection (at 810). Alternatively, the average molecular mass can be calculated from the particle concentration and image intensity value, and the average molecular mass can be compared to an average molecular mass threshold to determine the quality of the liquid beneficial agent.

Additionally or alternatively, the size, number or total mass of the photoluminescent particles obtained from the intrinsic fluorescence-based mode can be compared to a threshold. If the size, number or total mass of the photoluminescent particles exceeds the threshold, the quality of the liquid beneficial agent can be considered to be unacceptable, and a warning can be generated that the liquid beneficial agent has failed the inspection (at 810).

In addition, or as a further alternative, the analysis of the light scattering-based image, which as described herein can be used to find a size, mass or number of all particles, can be combined with the analysis of the intrinsic fluorescence-based image, which as described herein can be used to find a size, mass or number of photoluminescent particles (e.g., protein monomers and aggregates), to determine a size, mass or number of other particles (e.g., lubricant particles, air bubbles or other foreign particles). For example and without limitation, as embodied herein, the size, mass or number of other particles can be determined by taking the difference of the size, mass or number of all particles obtained from light scattering and the size, mass or number of photoluminescent particles obtained from intrinsic fluorescence, as described herein. Hence, in addition or as a further alternative, if the size, number or total mass of other particles exceeds a threshold, the quality of the liquid beneficial agent can be considered to be unacceptable, and a warning can be generated that the liquid beneficial agent has failed the inspection (at 810).

Additionally, or as a further alternative, a number of photoluminescent monomers forming an aggregate photoluminescent particle can be determined from the mass of the aggregate photoluminescent particle obtained by measuring the intensity of the particle, as described herein. Hence, if the mass of the aggregate photoluminescent particle (or a predetermined number of aggregate photoluminescent particles) exceeds a threshold, the quality of the liquid beneficial agent can be considered to be unacceptable, and a warning can be generated that the liquid beneficial agent has failed the inspection (at 810). As a further alternative, for background fluorescence from photoluminescent particles which do not form discrete particles in the image (e.g., due to imaging resolution limits), an average ensemble molecular mass or weight of these photoluminescent particles can be determined, which can be used to determine physical properties and/or quality of most of the photoluminescent particles in the beneficial agent (e.g., to confirm that the photoluminescent particles are mostly monomeric or mostly aggregated).

The method and system disclosed herein therefore can be used to confirm and/or determine acceptable quality levels of a beneficial agent in individual containers at a high-throughput rate. For example, if all the results of the image processing are evaluated and none of the results exceed predetermined threshold values, then the beneficial agent can be considered to be acceptable. An indication can be generated that the liquid beneficial agent has passed the inspection and/or a new beneficial agent can be made ready for inspection using the detection method.

Alternatively, or additionally, and in accordance with another aspect of the disclosed subject matter, the quality level can be a function of the results of the image processing techniques in combination. A representative profile can relate the results obtained by the image processing techniques to the quality level of the beneficial agent. The representative profile embodied herein can contain the particle concentration threshold, the total intensity threshold, the size, number or total mass of photoluminescent particles threshold and/or the size, number or total mass of other particles threshold that, if exceeded, indicate that the beneficial agent is unacceptable and does not pass inspection. The representative profile, and thus the particle concentration threshold, the total intensity threshold, the size, number or total mass of photoluminescent particles threshold, and/or the size, number or total mass of other particles threshold can be based on a variety of factors, including but not limited to the type of beneficial agent being inspected, the concentration of the beneficial agent being inspected, and the optical configuration of the detection system.

As described above with respect to systems 100 and 300 (FIGS. 1 and 3, respectively), the fluorescence and light scattering based detection utilized in system 700 provides that the minimum detectable particle size in either imaging mode is not diffraction limited. The minimum detectable particle size can be affected by the system signal-to-noise ratio and the camera sensitivity setting (for example, at the given laser excitation power) chosen for image acquisition and analysis. As such, protein aggregates down to a particle size in the range of about 50-100 nm can be evaluated with system 700 described herein, and the minimum particle size can be further improved by employing a higher quality light source. For purpose of illustration, and not limitation, the particle distribution lower end of the scale shown in FIG. 11 is set at 2.3 microns because the image analysis “filter” was selected at this limit, which can be used for purpose of comparison to existing methods like MFI (Micro-Flow Imaging™). The results of system 700 are similar to those with MFI (data not shown) when compared in this manner.

Systems and methods described herein can utilize both protein intrinsic UV fluorescence and intrinsic visible fluorescence as detection modalities. In this manner, protein aggregates can be characterized across a wide concentration range, which can be used, for example and without limitation, for biologics applications ranging from early R&D stages through production of the final manufactured prefilled device. The noninvasive system 700 described herein can allow for discrimination of protein aggregates from other particles in prefilled syringes, as well as total particle number, total aggregated protein mass, and protein aggregate size distribution. System 700 thus provides improved breadth of particle size range and smallest particle detection capability, for both proteinaceous and non-proteinaceous particles.

The systems and methods according to the disclosed subject matter can be automated, which can allow for high throughput screening of pre-filled syringes. During testing, several images of the same region of the syringe can be recorded in less than one second. By translating and rotating the syringe, multiple regions of the beneficial agent in the syringe can be evaluated.

In operation, the systems and techniques described herein can be implemented in a manufacturing environment for manufacturing syringes or for manufacturing a drug product contained in a prefilled syringe. For purpose of illustration and not limitation, with reference to FIG. 7, processor 740 can determine a container is suitable or unsuitable, as described herein, and can initiate a command to an automated manufacturing system to, for example and without limitation, reject an unsuitable container, provide an indication that a container is suitable or unsuitable, physically sort unsuitable containers from suitable containers, and/or load a new container for testing.

Processor 740 can perform the techniques described herein by executing software embodied in one or more tangible, computer-readable media, such as a memory unit. The memory unit can read the software from one or more other computer-readable media, such as a mass storage device or from one or more other sources via a communication interface. The software can cause the processor 740 to execute the particular analysis or response process or particular processes including defining data structures stored in the memory unit and modifying such data structures according to the processes defined by the software. Processor 740 can receive data from one or more input devices, for example and as embodied herein, the image detector including camera 730. Processor 740 can communicate with an output interface, such as a display to allow the processor to provide an indication to a user whether a container is of an acceptable quality, and/or to an automatic manufacturing system to perform packaging, rejecting, or sorting of containers based on the analysis. Additionally or alternatively, processor 740 can communicate with light source 710 and/or scanning device 750 to adjust the position and/or orientation of the light source 710 relative to the container 701 as described herein. Processors 140 and 340 (FIGS. 1 and 3, respectively) can be similarly configured.

The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method for inspecting particles in a liquid beneficial agent contained within a container, the liquid beneficial agent comprising photoluminescent particles, the method comprising:
selectively illuminating at least a portion of the liquid beneficial agent contained within the container using an excitation beam configured to excite the photoluminescent particles in the liquid beneficial agent to emit an emission light comprising an intrinsic photoluminescence of the photoluminescent particles and produce scattered excitation light;
filtering the illuminated portion of the liquid beneficial agent to transmit the emission light and block the scattered excitation light;
obtaining an image of the filtered emission light;
analyzing image data representing the image of the filtered emission light, using a data processor, to detect regions of the image representing the intrinsic photoluminescence of the photoluminescent particles;
measuring an intensity of the regions of the image representing the intrinsic photoluminescence of the photoluminescent particles using the data processor;
determining a size or number of the photoluminescent particles, using the data processor, from the measured intensity of the regions of the image representing the intrinsic photoluminescence of the photoluminescent particles; and
rejecting the liquid beneficial agent if the size or number of the photoluminescent particles exceeds a predetermined threshold.

2. The method of claim 1, further comprising positioning an image detector orthogonally to the excitation beam and obtaining the image of the filtered emission light using the image detector.

3. The method of claim 1, further comprising positioning an image detector in line with the excitation beam and obtaining the image of the filtered emission light using the image detector.

4. The method of claim 1, wherein the emission light is filtered using an optical filter disposed between the container and an image detector, the optical filter selected to isolate the intrinsic photoluminescence and block the scattered excitation light, wherein the image detector comprises a camera sensitive to UV or visible wavelengths, and wherein the camera comprises a microscope lens corresponding to the UV or visible wavelengths.

5. The method of claim 1, further comprising determining a number or mass of photoluminescent monomers forming aggregate photoluminescent particles, and rejecting the liquid beneficial agent if the number or mass of photoluminescent monomers forming the aggregate photoluminescent particles exceeds a threshold.

6. A system for inspecting particles in a liquid beneficial agent contained within a container, the liquid beneficial agent comprising photoluminescent particles, the system comprising:
a light source configured to provide an excitation beam to illuminate at least a portion of the liquid beneficial agent contained within the container, the excitation beam configured to excite the photoluminescent particles in the liquid beneficial agent to emit an emission light comprising an intrinsic photoluminescence of the photoluminescent particles and produce scattered excitation light;
an emission optical filter in optical communication with the emission light and configured to filter the illuminated portion of the liquid beneficial agent by transmitting the emission light and blocking the scattered excitation light;
an image detector configured to obtain an image of the filtered emission light; a data processor configured to receive image data representing the image from the image detector and programmed to:
analyze the image data representing the image of the filtered emission light to detect regions of the image representing the intrinsic photoluminescence of the photoluminescent particles;
measure an intensity of the regions of the image representing the intrinsic photoluminescence of the photoluminescent particles;
determine a size or number of the photoluminescent particles from the measured intensity of the regions of the image representing the intrinsic photoluminescence of the photoluminescent particles; and
reject the liquid beneficial agent if the size or number of the photoluminescent particles is above a predetermined threshold.

7. The system of claim 6, wherein the image detector is positioned orthogonally to the excitation beam.

8. The system of claim 6, wherein the image detector is positioned in line with the excitation beam.

9. The system of claim 6, wherein the image detector comprises a camera sensitive to UV or visible wavelengths, and wherein the camera comprises a microscope lens corresponding to the UV or visible wavelengths.

10. The system of claim 6, wherein the data processor is further configured to determine a number or mass of photoluminescent monomers forming aggregate photoluminescent particles, and reject the liquid beneficial agent if the number or mass of photoluminescent monomers forming the aggregate photoluminescent particles exceeds a threshold.

11. A method for inspecting particles in a liquid beneficial agent contained within a container, the liquid beneficial agent comprising photoluminescent particles and other particles, the method comprising:
selectively illuminating at least a portion of the liquid beneficial agent contained within the container using an excitation beam configured to excite the photoluminescent particles in the liquid beneficial agent to emit an emission light comprising an intrinsic photoluminescence of the photoluminescent particles, the illuminated portion of the liquid beneficial agent comprising the emission light and scattered excitation light comprising light scattered from the photoluminescent particles and light scattered from the other particles;
filtering the illuminated portion of the liquid beneficial agent using a first filter configured to block the emission light and transmit the scattered excitation light;
obtaining a first image of the illuminated portion of the liquid beneficial agent from the first filter;
filtering the illuminated portion of the liquid beneficial agent using a second filter configured to transmit the emission light and block the scattered excitation light;
obtaining a second image of the illuminated portion of the liquid beneficial agent from the second filter;
analyzing image data representing the first and second images of the illuminated portion of the liquid beneficial agent, using a data processor, to determine a size, number or
total mass of the photoluminescent particles and a size, number or total mass of the other particles; and
rejecting the liquid beneficial agent if the size, number, or total mass of the photoluminescent particles or the size, number or total mass of the other particles is above a predetermined threshold.

12. The method of claim 11, wherein the excitation beam has a wavelength within a range of an excitation band of the photoluminescent particles and within a range of a transmission band of the container.

13. The method of claim 11, wherein analyzing the image data comprises
determining a particle concentration and a total image intensity value from the image data representing the first image and determining a total particle intensity from the image data representing the second image.

14. The method of claim 11, wherein analyzing the image data comprises
determining a size, number or total mass of all particles in the liquid beneficial agent using the image data representing the first image and determining the size, number or total mass of the photoluminescent particles using the data representing the second image, whereby the size, number or total mass of the other particles is determined as a difference between the size, number or total mass of all particles and the size, number or total mass of the photoluminescent particles.

15. The method of claim 11, further comprising rotating or translating the container relative the excitation beam to obtain first and second images of different regions of the liquid beneficial agent.

16. A system for inspecting particles in a liquid beneficial agent contained within a container, the liquid beneficial agent comprising photoluminescent particles and other particles, the system comprising:
a light source configured to provide an excitation beam to selectively illuminate at least a portion of the liquid beneficial agent contained within the container, the excitation beam configured to excite the photoluminescent particles in the liquid beneficial agent and emit an emission light comprising an intrinsic photoluminescence of the photoluminescent particles and produce scattered excitation light comprising light scattered from the photoluminescent particles and light scattered from the other particles;
a first optical filter configured to be disposed in optical communication with and filter the illuminated portion of the liquid beneficial agent by transmitting the emission light and blocking the scattered excitation light;
a second optical filter configured to be disposed in optical communication with and filter the illuminated portion of the liquid beneficial agent by transmitting the emission light and blocking the scattered excitation light;
an image detector configured to configured to be disposed in optical communication the first and second optical filters and obtain a first image of the illuminated portion of the liquid beneficial agent from the first filter and a second image of the illuminated portion of the liquid beneficial agent from the second filter;
a data processor configured to receive image data representing the first and second images from the image detector and programmed to:
analyze the image data representing the first and second images of the illuminated portion of the liquid beneficial agent, using a data processor, to determine a size, number or total mass of the photoluminescent particles and a size, number or total mass of the other particles; and
reject the liquid beneficial agent if the size, number, or total mass of the photoluminescent particles or the size, number or total mass of the other particles is above a predetermined threshold.

17. The system of claim 16, wherein the excitation beam has a wavelength within a range of an excitation band of the photoluminescent particles and within a range of a transmission band of the container.

18. The system of claim 16, wherein the data processor is further configured to analyze the image data by determining a particle concentration and a total image intensity value from the image data representing the first image and determining a total particle intensity from the image data representing the second image.

19. The system of claim 16, wherein the data processor is further configured to analyze the image data by determining a size, number or total mass of all particles in the liquid beneficial agent using the image data representing the first image and determining the size, number or total mass of the photoluminescent particles using the data representing the second image, whereby the size, number or total mass of the other particles is determined as a difference between the size, number or total mass of all particles and the size, number or total mass of the photoluminescent particles.

20. The system of claim 16, further comprising a scanning device, in communication with the data processor, configured to rotate or translate the container relative the excitation beam to obtain first and second images of different regions of the liquid beneficial agent.

21.-40. (canceled)
